(19) United States
(12) Patent Application Publication
(10) Pub. No.: US 2023/0000108 A1
(43) Pub. Date: Jan. 5, 2023

(54) MEAT ANALOGUE PRODUCT AND METHOD

(71) Applicant: Bunge Loders Croklaan B.V., Wormerveer (NL)

(72) Inventors: Bastiaan Jeroen Victor VERKUIJL, Wormerveer (NL); Paul Jan Philip HUPPERTZ, Wormerveer (NL)

(73) Assignee: Bunge Loders Croklaan B.V., Wormerveer (NL)

(21) Appl. No.: 17/778,706

(22) PCT Filed: Nov. 19, 2020
(86) PCT No.: PCT/EP2020/082754

§ 371 Date: May 20, 2022

(30) Foreign Application Priority Data
Nov. 21, 2019 (EP) PCT/EP2019/082160

(51) Int. Cl. A23J 3/22; A23J 3/14; A23L 33/115

(52) U.S. Cl. CPC A23J 3/227; A23J 3/14; A23L 33/115

(57) ABSTRACT

The invention provides a meat analogue product comprising from 10-60% by weight vegetable protein, at least 0.1% by weight of binding agent, from 10-60% by weight of water, and from 5-40% by weight of non-hydrogenated vegetable fat; wherein the non-hydrogenated vegetable fat has a saturated fatty acid (SAFA) content of at least 40% by weight, and a solid fat content (SFC) at 20° C. of at least 20%. The invention also provides a method for making the meat analogue product.

### BACKGROUND

Meat analogue means a food made from vegetarian ingredients, excluding the use of animal meat and sometimes also exclude derived animal products such as dairy. Many analogues are soy-based (e.g. tofu, tempeh) or gluten-based, but now may also be pea protein-based. The market for meat analogues includes vegetarians, vegans, non-vegetarians seeking to reduce their meat consumption, and people following religious dietary laws.

The general consent is that the protein structure is by far the most determining factor that determines the texture and mouthfeel of the meat analogue product. Most new product development efforts revolve around further improving the texturization of vegetable proteins.

The listing of an apparently prior-published document in this specification should not necessarily be taken as an acknowledgement that the document is part of the state of the art or is common general knowledge.

WO2017070303 (Beyond Meat) describes a vegetarian meat-like food product, comprising structured protein products bound together by binding agents, resulting in a product with physical, textural and sensory properties comparable to animal meat. The properties are said to be due to the microscopic protein structure.

WO 2015/153666 (Impossible Foods) describes a meat replica composition comprising 5% to 88% by weight of a meat dough, comprising an isolated plant protein and an edible fibrous component; 0% to 40% by weight of a carbohydrate-based gel, 5% to 35% by weight of a non-animal fat and a flavoring agent selected from a cucumber extract or a melon extract; a binding agent; and a heme-containing protein and/or an iron salt, in particular Leghemoglobin.

Meat analogue products would typically require cooking before their organoleptical properties can be appreciated. The cooking typically involves a heat treatment above 100° C., and may for instance involve baking, grilling, boiling or microwave cooking. Typically, the product reaches elevated temperatures above 100° C., and the meat analogue composition will undergo chemical transformations, in particular denaturation of the proteins, and will evaporate part of the water, mostly depending on applied temperature and cooking duration.

### DESCRIPTION

It is a subject of the current invention to provide a meat analogue product with acceptable organoleptic properties. It is another subject of the invention to provide a meat analogue product with improved organleptic properties.

Meat Analogue product, comprising; from 10-60% by weight vegetable protein; at least 0.1% of binding agent; from 10-60% by weight of water; from 5-40% by weight of non-hydrogenated vegetable fat; wherein the vegetable fat has a saturated fatty acid (SAFA) content of at least 40%, and a solid fat content (SFC) at 20° C. of at least 20%. Typically, the SFC is measured according to ISO 8292-1 (non-stabilized).

Preferences and options for a given aspect, feature or parameter of the invention should, unless the context indicates otherwise, be regarded as having been disclosed in combination with any and all preferences and options for all other aspects, features and parameters of the invention.

It was found that the fat phase has a surprisingly large impact on the sensory properties of meat analogues. Meat analogues with the fat phase according to the invention will, after cooking, have acceptable organoleptic properties. In particular, it was found that the vegetable fat used as per the invention, improves organoleptic properties compared to reference meat analogue products. Also, the meat analogue products according to the invention were easy to process in food processing equipment such as mixers and extruders.

Comparing to some known fats used in meat analogue products, the known fats used have a lower SAFA and/or a lower solid fat content at 20° C.

WO2017070303A1 mentions using about 25% lipid, and in the example 3 shows hydrogels based on agar/water with added canola oil, coconut oil or palm oil. The meat-like food products in table 7 use 36-45% meat structured protein product, and about 10-25% of this hydrogel ‘agent release system’, the hydrogel made of 36.5% water, 1.4% agar, 2.4% Pea protein isolate, 12.2% coconut oil, 42.6% canola oil, and 4.9% taste agent, hence the hydrogel comprises about 54.8% lipids. Canola oil is a liquid oil at room temperature (20° C.), whereas coconut oil has a relatively low slip melting point. Of 24-26° C., just above room temperature (Ullmann's encyclopedia of industrial chemistry, Vol A 10, Fats and oils, VCH, Weinheim 1995).

In WO 2015/153666 (Impossible Foods), example 6 describes the preparation of a ‘flavored infused fat replica’ based on the iron-containing protein Leghemoglobin; this component also includes RBD coconut oil, and is used in the burger product described in example 11 in an amount of 13.5% fat and 54.1% of a vegetable-based ‘meat dough’. A similar fat replica based on coconut oil is made in example 15 used in an amount of 9-10% in example 16-18. Example 23 describes ‘adipose replica’ and uses a 1:1 mix of coconut oil and an unspecified palm stearin.

WO 2014/110532 describes taste compositions including iron-binding heme proteins, and includes coconut oil as a vegetable fat in the examples.

WO 2013/010042 describes making a fat tissue analog including rice bran oil. Rice bran oil is a liquid oil at room temperature.

Vegetable proteins can be proteins from various plant sources, such as soybeans, peas, sunflower, rape and various other vegetable sources. Protein content of a food product can for instance be determined by AOAC International reference methods AOAC 990.03 and AOAC 992.15. Proteins from various sources can be mixed. Proteins from sources that are free of allergens are preferred.

Numerous protein forms suitable for food applications are commercially available. The proteins can be in their native form but may also be treated and provided as denaturated and/or partially hydrolyzed proteins.

Water is typically present as a component in food ingredients in various amounts, for instance bound to proteins. Additional water or water containing ingredients can be added in order to arrive at a desired moisture level. Water can also be used to add dissolved food additives such as salt and flavoring.

Binding agents re defined as agents that provide a bound structure and enable the other components to form a cohesive mass. In particular the binding agent help to include fat, water and proteins into the product. A plethora of suitable food binding agents is known in the art. Typically, multiple binding agents are used in combination to form a bound structure in the complete product.

The term “fat” refers to glyceride fats and oils containing fatty acid acyl groups and does not imply any particular melting point. The term “oil” is used synonymously with “fat”. Fat/lipid content of a food product can be determined by various methods, for example AOAC International reference method AOAC 954.02.

The term “fatty acid” refers to straight chain saturated or unsaturated (including mono- and poly-unsaturated) carboxylic acids having from 8 to 24 carbon atoms. A fatty acid having x carbon atoms and y double bonds may be denoted Cx:y. For example, palmitic acid may be denoted C16:0 and oleic acid may be denoted C18:1.

Percentages of fatty acids in compositions referred to herein include acyl groups in tri-, di- and mono-glycerides present in the glycerides and are based on the total weight of C8 to C24 fatty acids. The fatty acid profile (i.e., composition) maybe determined, for example, by fatty acid methyl ester analysis (FAME) using gas chromatography according to ISO 12966-2 and ISO 12966-4.

The term “triglyceride” refers to glycerides consisting of three fatty acid chains covalently bonded to a glycerol molecule. said percentages of acid referring to acids bound as acyl groups in glycerides in the fat composition and being based on the total weight of C8 to C24 fatty acids.

The SAFA-content being defined as the total weight of saturated fatty acids (including the trans-acids) over the weight of all fatty acids present.

The SFC value preferably is measured by NMR-pulse, using the method described in ISO 8292-1 (non-stabilized). The method involves melting a sample, and cooling down to the desired measure temperature, followed by determining the solid fat content by NMR.

Preferences and options for a given aspect, feature or parameter of the invention should, unless the context indicates otherwise, be regarded as having been disclosed in combination with any and all preferences and options for all other aspects, features and parameters of the invention.

In a preferred embodiment, the meat analogue product has an amount of protein from 15-50% by weight, preferably from 15-40% by weight.

In another preferred embodiment, the amount of fat is from 5-35% by weight, preferably from 10-30% by weight.

It is preferred if the ratio by weight of protein and fat is from 4:1 to 1:4, preferably from 3:1 to 1:2, more preferably from 2:1 to 1:1. In these ratios, the organoleptic properties of the product are particularly favorable.

In a preferred embodiment, the binding agents comprise one or more binding agents selected from starch, gluten, puree, starches, gums and polysaccharides. Popular binding agents known in the art comprise bean puree, potato puree, potato starch, corn starch, tapioca starch, pea starch, wheat gluten, corn gluten, rice gluten, xanthan gum, guar gum, locust bean gum, gellan gum, Arabic gum, methylcellulose, hydroxypropyl methylcellulose, carboxymethyl cellulose, maltodextrin, and carrageenan. Natural origin binding agents are preferred.

In a preferred embodiment, the vegetable fat has a monounsaturated fatty acid content of 20-40%.

In another preferred embodiment, the vegetable fat has a polyunsaturated fatty acid content of less than 10% by weight.

It is preferred if the vegetable fat has a solid fat content at 20° C. of at least 30%, more preferably at least 40%, more preferably at least 50%, more preferably at least 60%. The higher solid fat content provided a meat analogue product that was easier to process in food processing equipment such as mixers or extruders. Preferably, vegetable fat has a solid fat content at 20° C. from 20 to 80%.

Preferably, the vegetable fat has a fatty acid content having a C12:0 content of less than 10% by weight, preferably less than 8%, more preferably less than 6%, more preferably less than 4%, more preferably less than 2%, more preferably less than 1%. Typical sources for C12 fatty acids are coconut oil and palm kernel oil.

In a preferred embodiment, the vegetable fat has a fatty acid content wherein the sum of C16:0 and C18:0 is at least 40%, preferably from 40-80%, more preferably from 50-70%.

It is preferred if the vegetable fat comprises less than 2% trans fatty acids, preferably less than 1% trans fatty acids. Partial hydrogenation of vegetable fats results in the formation of trans-fats, and high amounts of trans fatty acids are undesirable from a health perspective. Non-hydrogenated vegetable fats are therefore preferred.

It is preferred if the vegetable fat has at least 40% C16:0, more preferably at least 50% C16:0. A typical vegetable source for C16:0 is palm oil.

Preferably the vegetable fat comprises palm stearin. The stearin fraction of palm oil provides good organoleptic properties to the product. More preferably, the vegetable fat comprises interesterified palm stearin. Interesterified palm stearin provides more desirable organoleptic properties than non-interesterified palm stearin.

In another preferred embodiment, the vegetable fat comprises at least 40% C18:0, more preferably a least 50% C18:0. Preferably, the vegetable fat comprises at least one fat derived from shea, illipe, sal, kokum, allanblackia or mango. These fats are relatively rich in C18:0. Most preferably, the vegetable fat comprises shea stearin. The stearin fraction of shea butter provides good organoleptic properties to the product. In a preferred embodiment, the vegetable fat is essentially free of palm fat. By “essentially free”, we include the meaning that the vegetable fat contains less than 1% by weight palm fat, preferably less than 0.5% by weight, more preferably less than 0.1% by weight, most preferably free of palm fat.

The invention also provides a method for the preparation of a meat analogue product according to any of the preceding claims, comprising the steps of: Providing protein of vegetable origin; Providing at least one binding agent; Providing water; Providing a non-hydrogenated vegetable fat, having a saturated fatty acid content of at least 40%, and a solid fat content at 20 degrees C. of at least 20%; Mixing the protein, binding agent, water and non-hydrogenated vegetable fat.

Subsequently, the meat analogue product may be brought in a desired form, such as a burger, a ball, a sausage or a skewer. The meat analogue may subsequently be cooked, for instance by baking or grilling.

In a preferred embodiment, the vegetable fat is provided as flakes or as a dry powder. Flakes or dry powders are easier to mix in the product without the need for melting the fat first.

The invention will now be elucidated based on the following non-limiting examples.

### EXAMPLE 1

Three fats for testing were prepared from commercially available sources. Fat A is an interesterified palm stearin, prepared by chemical interesterification of a blend of 90% palm oil stearin IV 35 and 10% palm oil stearin IV 4. Fat B is a shea stearin, selected to have a similar SAFA value as Fat A. For standardization, the shea stearin can be mixed with a liquid oil, preferably shea olein. Fat C is a reference fat, consisting of a blend of 75% sunflower oil and 25% coconut oil. Fat C was selected as a reference as it has properties comparable to the coconut oil-based fat components used in several meat analogue products, comparable for example with the coconut/canola examples described in WO2017070303 (Beyond Meat).

| | | Fat A | Fat B | Fat C (ref) |
|---|---|---|---|---|
| | | Interesterified | Shea | Sunflower 75% - |
| Parameter | Unit | Palm Stearin | stearin | Coconut 25% |
| IVFAME | g/100 g | 31.5 | 32.0 | 98.2 |
| SAFA | % | 69.3 | 65.6 | 29.6 |
| MUFA | % | 24.9 | 31.4 | 26.9 |
| PUFA | % | 5.8 | 2.9 | 43.3 |
| trans | % | <0.1 | <0.1 | <0.1 |
| C8:0 | % | 0.0 | 0.0 | 1.4 |
| C10:0 | % | 0.0 | 0.0 | 1.2 |
| C12:0 | % | 0.3 | 0.2 | 10.9 |
| C14:0 | % | 1.3 | 0.1 | 4.6 |
| C16:0 | % | 61.2 | 4.0 | 7.2 |
| C18:0 | % | 5.7 | 59.2 | 3.2 |
| C18:1 | % | 24.7 | 31.4 | 26.7 |
| C18:2 | % | 5.6 | 2.8 | 43.2 |
| C20:0 | % | 0.4 | 1.7 | 0.2 |
| SFC 0° | % | | 98 | 18.3 |
| SFC 5° | % | | | 14.4 |
| SFC 10° | % | 94 | 91 | 6.9 |
| SFC 15° | % | 72 | | 1.4 |
| SFC 20° | % | 72 | 82.2 | 0.0 |
| SFC 25° | % | 61 | 76.2 | 0.0 |
| SFC 30° | % | 49 | 64.8 | 0.0 |
| SFC 35° | % | 42 | 8.3 | 0.0 |
| SFC 40° | % | 30 | 2.5 | 0.0 |
| SFC 45° | % | 10 | | |

In the Above Table:

1. IV FAME refers to calculated iodine value according to ROCS Cd 1 c-85;

2. SAFA refers to saturated fatty acids;

3. MUFA refers to mono-unsaturated fatty acid;

4. PUFA refers to poly-unsaturated fatty acid;

5. TRANS refers to trans fatty acids: unsaturated fatty acids having a double bond in a trans arrangement.

6. Cx:y refers to a fatty acid having x carbon atoms and y double bonds; levels determined by GC-FAME (ISO 12966-2: 2014 and ISO 12966-4: 2015)

7. S20-Nx refers to solid fat content determined by NMR on unstabilized fat measured at x° C. according to ISO 8292-1.

### EXAMPLE 2: MEAT DOUGH PRODUCT PREPARATION

Meat products in the form of a meat dough were prepared according to the recipe below, wherein the added fat was either Fat A, fat B, or reference fat C. Fat A was provided in the form of flakes, and could be added conveniently as dry matter. Fat C was somewhat inconvenient to handle at room temperature and was first heated until 60° C. and subsequently poured into the mixture as a liquid.

| | Relative Amounts g |
|---|---|
| Ingredient | |
| Mungbeans (cooked) | 27 |
| Broth | 25 |
| Wheat gluten | 10 |
| Super pea protein isolate | 10 |
| Bread crumbs | 4 |
| Potato starch | 4 |
| Tomato puree | 6 |
| Additives | |
| Burger spices (no salt) | 2.5 |
| Yeast extract | 1.5 |
| salt | 0.5 |
| Paprika powder | 1 |
| Smoke flavor | 0.2 |

The fat was mixed into the mixture with the use of a Hobart mixer with the other dry ingredients and the additives were added. Subsequently the mungbeans, tomato puree and broth were added during mixing until a homogeneous dough was obtained.

Mungbeans and super pea protein isolate are the main protein sources in the recipe. The wheat gluten, bread crumbs, potato starch and tomato puree form a binder component, but alternative biding agents could be used. Broth (based on 20 g dry material per 100 g) is added for tastiness and a source of water. Tomato puree, apart from having some binding properties, also contributes to color and taste. The other additives are contributing to the taste.

Total food constituents composition of the uncooked meat dough was calculated based on the basis of the constituents of the ingredients based on the data as documented by the ingredient supplier. Some of the ingredients contain minor amounts of fat, hence the total fat amount is slightly higher than the added fats A or B.

TABLE
Calculated food composition of uncooked meat-replacer dough

| | Amounts g/100 g |
|---|---|
| Fat | 15 |
| Incl. Saturated fat | 7 |
| Carbohydrates | 14 |
| Incl. Sugars | 3 |
| Protein | 19 |
| Salt | 1 |
| Dietary fibers | 2 |
| Water | 49 |

### EXAMPLE 3: COOKING AND SENSORY EVALUATION OF THE COOKED MEAT ANALOGUE PRODUCT

The meat dough below can be used in many different forms ready for further cooking, baking or grilling. For the sensory evaluation, the meat dough was processed in the form of 40 g burgers, that were preheated at 80° for 15 minutes and then cooled down to room temperature. Prior to serving, the burgers were baked under controlled temperature and baking duration. The freshly baked products were tested for the following organoleptic properties.

Properties Tested by a Trained Test Panel:

1. Firmness/Hardness: indicates how firm a product feels when biting of a piece, ranging from no resistance to a firm texture.

2. Chewiness/Bite: means how long a part of product of predetermined size needs to be chewed before able to swallow, ranging from ‘chewy’ to ‘tender’.

3. Cohesiveness: Is the product falling apart or is it staying together in the mouth, ranging from products that readily fall apart to products that stay together.

4. Springiness/resilience: Is the product going back in the original shape or does it stay deformed after applying mechanical pressure with the teeth (without biting through the product)? Ranging from products that stay deformed to products that return to their original shape.

5. Mouth feel: means how texture of the sample feels in the mouth, ranging from ‘dislike’ to ‘pleasant’.

6. oiliness/fat: does the sample feel fat or oily in the mouth, ranging from ‘oily’ where the fatty component disappears rapidly from the mouth after eating, to products denoted as ‘waxy’, wherein the fatty component lingers in the mouth after eating.

7. Juiciness: refers to how moist the sample feels in the mouth and how much moisture release is experienced in the mouth after chewing. Ranging from ‘dry’ to ‘juicy’.

8. Total appreciation: The overall judgement of the sample compared to reference, ranging from ‘dislike’ to ‘appreciated’.

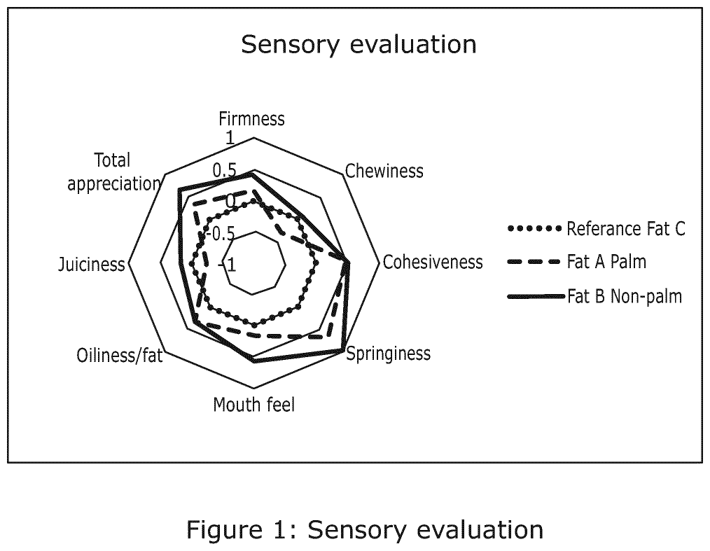

The burgers were tested by a trained test panel. Both fats A and B had a better total appreciation than the reference fat C. The results are shown in spider plot FIG. 1.

Fat A showed a relatively higher firmness, cohesiveness, springiness, mouthfeel and oiliness, and a lower Chewiness and Juiciness that the reference fat C. In particular, fat scored better on Cohesiveness and Springiness.

Fat B showed a relatively higher firmness, cohesiveness, springiness, mouthfeel and oiliness, Chewiness and Juiciness than the reference fat C, wherein Firmness, Cohesiveness, Cohesiveness and Mouthfeel stood out in particular.

Comparing Fat A and B, the non-palm fat B had a higher total appreciation than Fat A, and scored in particular better on Chewiness, Mouthfeel and Juiciness.

1. Meat Analogue product, comprising from 10-60% by weight vegetable protein;
at least 0.1% by weight of binding agent;
from 10-60% by weight of water;
from 5-40% by weight of non-hydrogenated vegetable fat; wherein the vegetable fat has a saturated fatty acid (SAFA) content of at least 40%, and a solid fat content (SFC) at 20° C. of at least 20%.

2. Meat analogue product according to claim 1, wherein the amount of protein is from 15-50% by weight.

3. Meat analogue product according to claim 1, wherein the amount of fat is from 5-35% by weight.

4. Meat analogue product according to claim 1, wherein the vegetable fat has a monounsaturated fatty acid content of 20-40%.

5. Meat analogue product according to claim 1, wherein the vegetable fat has a polyunsaturated fatty acid content of less than 10% by weight.

6. Meat analogue product according to claim 1, wherein the vegetable fat has a solid fat content at 20° C. of at least 30%.

7. Meat analogue product according to claim 1, wherein the vegetable fat has a fatty acid content having a C12 content of less than 10% by weight.

8. Meat analogue according to claim 1, wherein the vegetable fat has a fatty acid content wherein the sum of C16:0 and C18:0 is at least 40%.

9. Meat analogue product according to claim 1, wherein (i) the vegetable fat has a fatty acid content having at least 40% C16:0; and/or (ii) the vegetable fat comprises at least 40% C18:0.

10. Meat analogue product according to claim 9, wherein the vegetable fat comprises palm stearin, or interesterified palm stearin.

11. Meat analogue product according to claim 10, wherein the vegetable fat comprises at least one fat derived from shea, illipe, sal, kokum, allanblackia and mango.

12. Meat analogue according to claim 10, wherein the vegetable fat comprise less than 1% by weight of fat components derived from palm oil.

13. Meat analogue product according to claim 1, wherein the vegetable fat comprises shea stearin.

14. Method for the preparation of a meat analogue product according to claim 1, comprising the steps of:
providing protein of vegetable origin;
providing at least one binding agent;
providing water;
providing a non-hydrogenated vegetable fat, having a saturated fatty acid content of at least 40%, and a solid fat content at 20 degrees C. of at least 20%;
mixing the protein, binding agent, water and non-hydrogenated vegetable fat.

15. A method according to claim 14, wherein the vegetable fat is provided as flakes or as a dry powder.
